(19) United States
(12) Patent Application Publication
(10) Pub. No.: US 2010/0187891 A1
(43) Pub. Date: Jul. 29, 2010

(54) Chair and Method of Manufacturing Same Using Gas Assist Injection Molding

(75) Inventors: William G. O'Connor, Chicago, IL (US); Matthew F. O'Connor, Chicago, IL (US)

Correspondence Address: DAVID I. ROCHE;BAKER & MCKENZIE LLP, 130 EAST RANDOLPH DRIVE, CHICAGO, IL, 60601, US

(73) Assignee: Commercial Plastics Company

(21) Appl. No.: 12/359,848

(22) Filed: Jan. 26, 2009

(51) Int. Cl. A47C 5/12; B29C 45/00

(52) U.S. Cl. 297/451.13; 264/537

(57) ABSTRACT

A chair comprising a combination of injection molded components. The combination includes a gas assist molded rear frame and a gas assist molded front frame. A seat is injection molded using regular injection molding. The seat joins the uppermost part of the front from to a mid-portion of the rear frame. In addition, four connecting rods are insert molded such that plastic jackets surround metal cores. The metal cores have fastening means integrated into their ends. Each of the connecting rods joins and abuts protrusions formed in and extending from the front and rear frames. All of the resin used to mold the frames, seat and connecting rods is a polycarbonate which provides a chair made of the combination with a crystal-like appearance.

### BACKGROUND AND SUMMARY OF THE INVENTION

The inventions described herein relate to a chair of the type known as a Chiavari-style chair. In particular, the inventions described herein relate to an injection molded chair in which the main structural components are generally hollow and made using a process known as gas assist injection molding (GAIM).

Chiavari-style chairs are well known in the art. For example, U.S. Pat. No. 6,666,518 shows a stackable Chiavari-style chair. In addition, a company called Commercial Seating Products in Ridgefield Park, N.J. sells a Chiavari chair having an outer layer of plastic and a steel inner frame that extends throughout the chair. See the website of Commercial Seating Products at http://www.cspevents.com/products/rb700.html where the chair described at that site is said to be the subject of a pending patent application Ser. No. 11/291,792, filed Dec. 1, 2005. The plastic-coated steel frame chair of Commercial Seating Products is said to be made of K-resin which is a styrene butadiene block copolymer material.

The inventions described herein make use of an injection molding technology known as gas assisted injection molding or GAIM. GAIM is known to improve cycle times, lower product weight and reduce the amount of plastic used to make products. GAIM also affords design flexibility and allows the manufacture of structurally stronger parts. GAIM involves the use of a gas, preferably nitrogen, to displace resin in flow channels of a mold. Nitrogen gas is preferred because it is relatively inert, dry, non-toxic, and odorless. Nitrogen has the ability to contact melted resin at high temperatures without introducing oxidation of the resin.

Chiavari chairs are very popular for use at events such as weddings. Rental companies typically maintain a large inventory of Chiavari chairs. However, because the design of Chiavari chairs is more elegant than structurally robust, Chiavari chairs have typically had a relatively short life cycle, requiring rental companies to purchase replacement Chiavari chairs on a regular basis.

Typically, Chiavari-style chairs are made of wood and are quite fragile, particularly when used as rental chairs where the chair is not generally treated in careful manner appropriate to their structural strength. The chair offered by Commercial Seating Products may be more structurally robust, but is both expensive and heavy because of its structural steel frame.

The Chair described herein is both durable and structurally robust without being excessively expensive. The chair is comprised of a front and rear frame each of which contains two at least partially hollow posts at opposite sides. Connecting in the posts are rods that are preferably at least partially hollow. Preferably four front-to-rear connecting rods join the front and rear frames. The connecting rods are comprised of insert molded jackets surrounding a simple metal core adapted to be fastened at each end to one of the frames. A seat comprising a circumferential lip as sockets near the frontend of the seat adapted to receive the upper ends of the posts of the front frame. Preferably a total of 10 fasteners are used to assemble the chair. Two fasteners connect the rear of the seat to the middle portion of the rear frame. Eight fasteners, one for each end of the four front-to-rear connecting rods are used to fasten the connecting rods to the front and rear frames. The front and rear frames are preferably made using GAIM technology, which allows the formation of large portions of the volume of the front and rear frames to be hollow, thereby saving in resin and weight. The plastic used to injection mold the front and rear frames, the seat, and the jackets surrounding the front-to-rear connecting rods is preferably a polycarbonate, because of its strength, toughness and transparency.

These and other advantageous features of the chair described herein will be better understood and appreciated by those skilled in the art by referenced to the following specification, read in conjunction with the accompanying drawings.

### DESCRIPTION OF THE DRAWINGS

FIG. 1 is an exploded perspective view of a chair including a seat, front and rear frames and four front-to-rear connecting rods (fasteners are not shown);

FIG. 2 is a rear elevational view of the rear frame of the chair shown in FIG. 1;

FIG. 3 is a rear elevational view of the front frame of the chair shown in FIG. 1;

FIG. 4 is an elevational view of a front-to-rear connecting rod of the chairs shown in FIG. 1;

FIG. 5 is a bottom exploded plan view of the seat of the chair shown in FIG. 1;

FIG. 6 is a an enlarged perspective view of the upper part of the front frame shown in FIG. 1; and

FIG. 7 is an upwardly directed exploded view in partial section of a chair embodying the inventions described herein.

### DETAILED DESCRIPTION

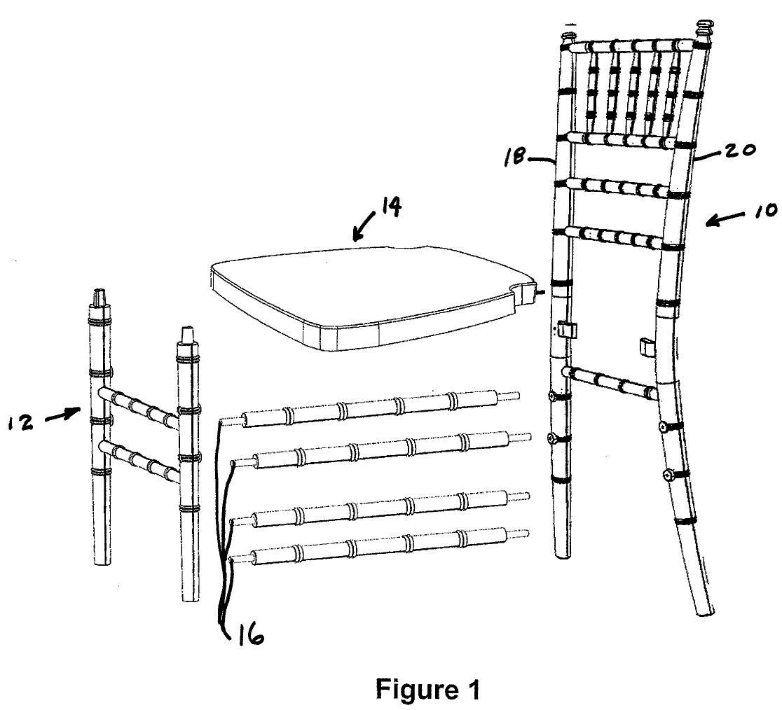

FIG. 1 is an exploded view of a chair embodying the inventions described herein. A front frame 12 and a rear frame 10 are facing each other such that four front-to-rear connecting rods 16 may connect the front frame 12 to the rear frame 10 with the front portion of the seat 14 adapted to engage the top of the front frame 12 and the rear potion of the seat adapted to be connected to a middle portion of the rear frame 10.

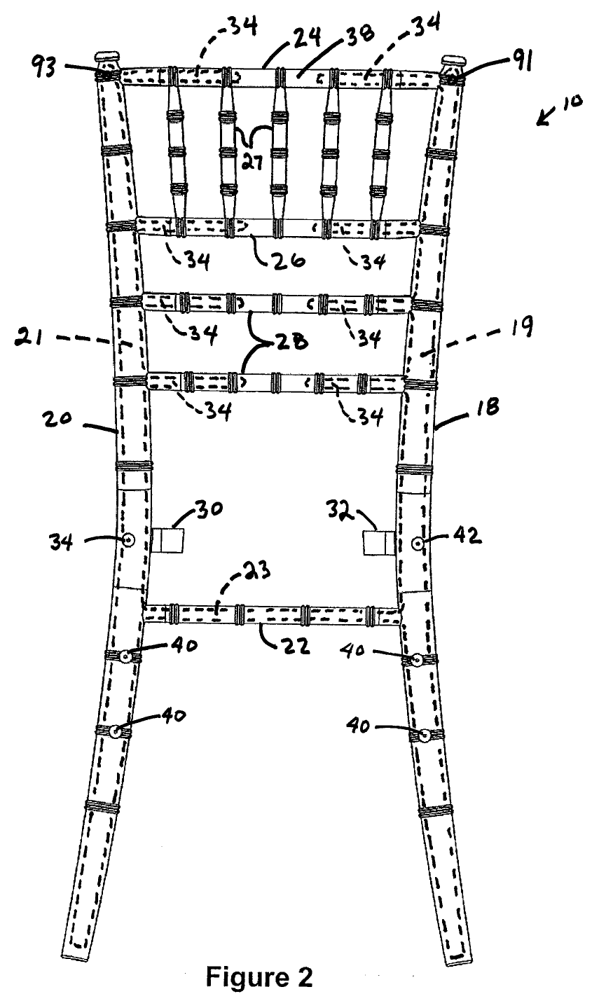

FIG. 2 shows the rear frame 10 in more detail. Two substantially hollow posts 19 and 20 are the main structural members of the rear frame 10. In this particular exemplary embodiment, five crossbars extend from one post to the other. While this particular arrangement is designed to result in a Chiavari-style chair, it will be recognized by persons of skill in the art of injection molding and chair design that the inventions described herein have ready application to chairs other than Chiavari-style chairs. An upper crossbar 24 and a second crossbar 26 have a series of vertical rods 27 extending between them. The upper crossbar 24 has a partially hollow core formed by hollow cores 34 and 36 separated by a solid center core 38. Crossbar 26 is configured in a partially hollow manner, similar to cross bar 24, as are the crossbars 28. The hollow core 19 within the post 18 is in fluid communicates with (i.e., is open to) the hollow core 21 of post 20 through the hollow core 23 in the lower crossbar 22.

The hollow cores 34 of the crossbars 24, 26 and 28 do not extend entirely through those crossbars, but could be, if desired, depending on their size and other variable used in the GAIM process, such as the viscosity of the resin, diameter of the sections and the pressure of the gas. The viscosity and size of the flow channels in the cavity used to make the rear frame 10 result in the hollow sections produced by the pressurized gas during the GAIM process, and a substantial majority of the axial length of the elongate portions that comprise the rear frame and the front frame are hollow and made entirely of gas assist molded plastic. The fact that a majority of the interior of the segments of the rear and front frames is hollow substantially saves on the resin used to make the rear frame 10, making the chair both light and very strong, particularly when the resin used is polycarbonate.

The rear frame 10 contains features that facilitate assembly of the chair described herein. At the level where the seat 14 attaches to the rear frame 10, two ears 30 and 32 extend laterally inwardly from the posts 20 and 18, respectively. At that same elevation, recesses 34 and 42 are formed in the rear face of the posts 20 and 18, respectively, for accommodating the heads of fasteners (not shown) that connect the rear of the seat 14 to the rear frame 10. Similarly, at the elevation of the front-to-rear connecting rods a series of recesses 40 are formed in the rear face of the posts 20 and 18. The recesses 34, 40 and 42 are adapted to receive the head of a bolt or screw (not shown) that engages the ends of the front-to-rear connecting rods 16.

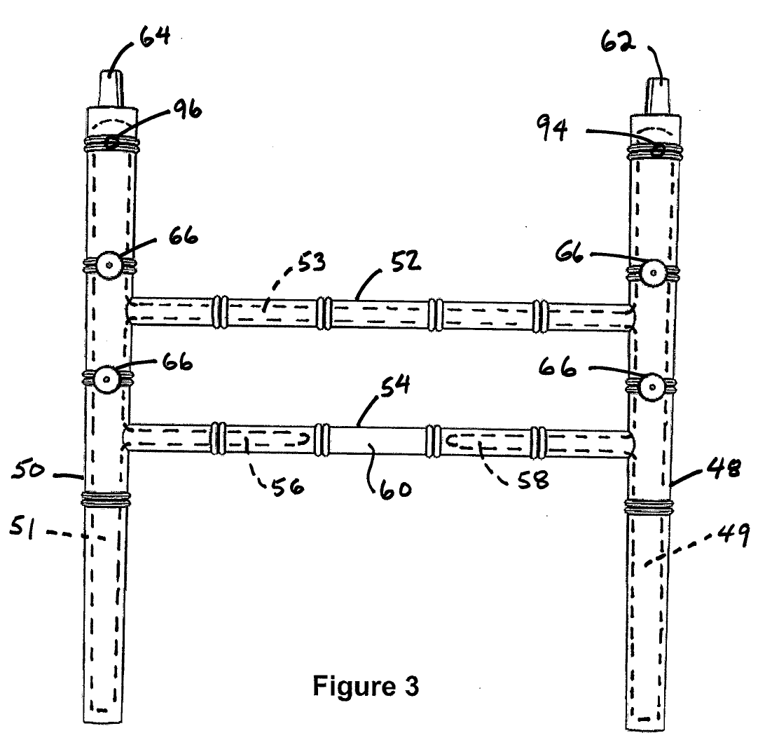

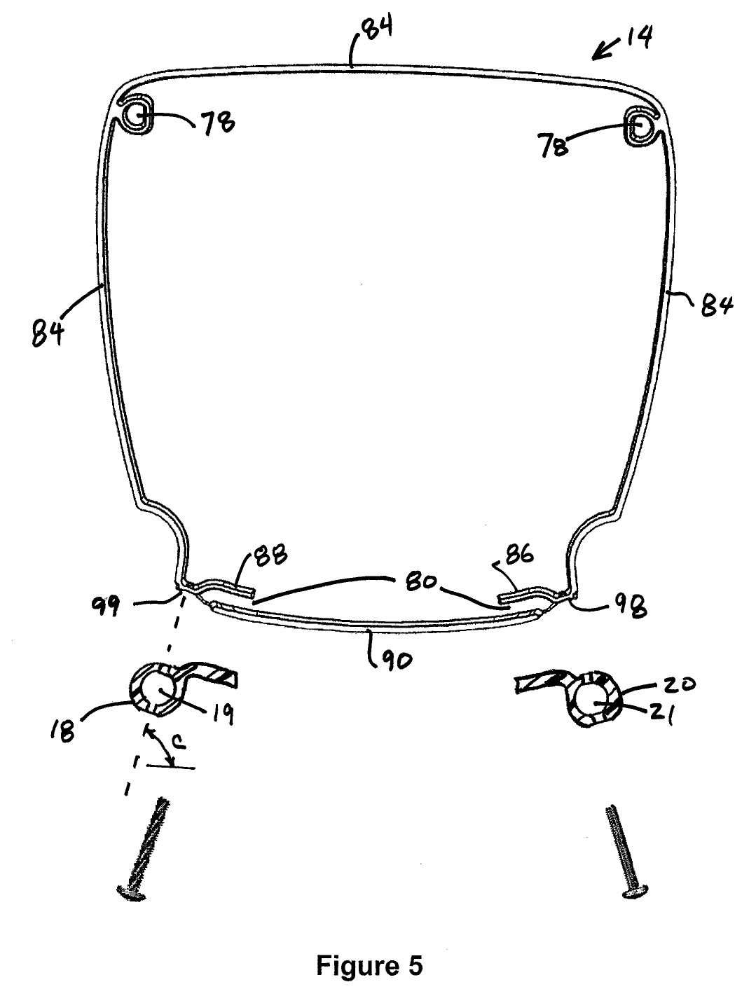

FIG. 3 is a rear elevational view of the front frame 12. As with the rear frame 10, the front frame 12 is comprised of two main structural members in the form of post 48 and post 50, each of which has a substantially hollow core, 49 and 51, respectively. Each of the posts 48 and 50 has a tapered upper end forming a D-shaped plug 62 and 64, respectively. The D-shaped plugs 62 and 64 fit tightly into corresponding recesses 78 formed in the underside of the seat 14 (see FIG. 5). Each of the posts 48 and 50 have a pair of protrusions 66 that contain an annular flat against which a shoulder on the connecting rods 16 bears.

The front frame 12 shown in FIG. 3 has a substantially hollow interior portion comprised of hollow cores 49 and 51 inside the posts 48 and 50, respectively. The hollow core 49 communicates with the hollow core 51 through a hollow core 53 in the upper rung 52. Hollow sections 56 and 58 are formed in the lower rung 54, and are separated by a solid portion 60 inside the lower rung 54. It should be noted that, depending upon the material used and the pressures used during the GAIM process, the lower rung 54 could be hollow throughout its length as is the upper rung 52. Alternatively, the upper rung 52 could be partially hollow as is the lower rung 54, as depicted in FIG. 3.

In each of the rear frame 10 and front frame 12, the hollow areas within those frames are formed by the insertion of gas during the molding process at ports which are formed at the upper ends of each frame, and the frames 10 and 12 have not metal reinforcing, i.e., they are unreinforced. In the particular embodiment shown, the rear frame has first and second ports 91 and 93 at the upper ends of the posts 18 and 20 respectively at the elevation of the upper crossbar 24. The ports 94 and 96 in the front frame 12 are similarly located, i.e., just below the upper ends of the posts 48 and 50, respectively. It should be noted that locating the ports at alternative locations could result in a formation of a hollow interior which is configured to somewhat differently than is depicted in FIG. 3 with respect to the front frame and a different configuration of hollow areas could be formed in the rear frame member than is depicted in FIG. 2.

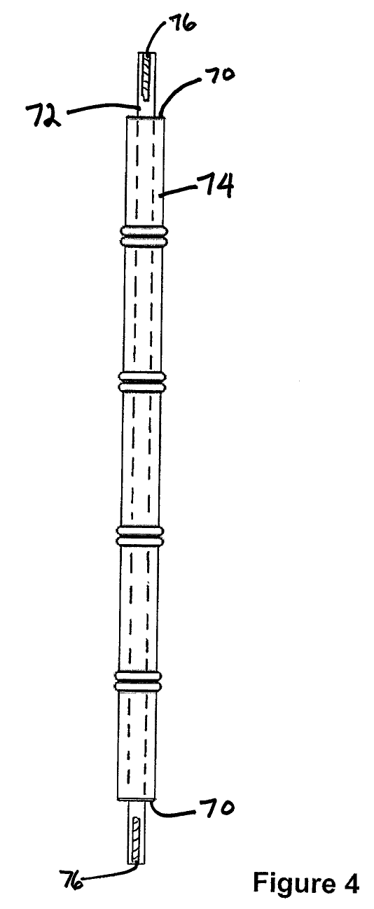

FIG. 4 shows a connecting rod 16, which is preferably made without the use of GAIM technology, but instead uses insert molding technology whereby a steel rod 72 is placed in a mold and a jacket 74 is molded around the steel rod 72. The connecting rod 16 has annular flats 70 at each end of the jacket 74. The annular flat 70 engages similarly shaped annular flats 66 on the front frame 12 and similarly shaped annular flats 68 on the rear frame 10. Internally threaded bores 76 receive a bolt or screw (not shown) that extends through either the front frame 12 or the rear frame 10, depending on which end of the rod is being connected. While the particular embodiment shown herein uses an internally threaded bores, connection could alternatively be made by other types of connections, such as a slightly longer steel rod with externally threaded ends, which could then allow the rods 16 to be connected by nuts bearing against the front and rear frames. Persons of skill in the art may use any of several other alternative connecting systems well-known in the art.

The seat 14 shown in FIG. 5 has D-shaped sockets 78 in the corners of the front side of the seat 14. The D-shaped sockets 78 are adapted to receive and tightly engage the tapered D-shaped plugs 62 and 64 on the upper ends of the posts of the front frame 12. The seat 14 has a downwardly depending substantially circumferential flange 84 extending around three sides, i.e., the front and the two sides of the seat. The flange 84 has two inwardly pointing extensions 86 and 88 that, in combination with a rear flange 90, form slots 80 into which the ears 30 and 32 are intended to fit to provide vertical support for the seat 14, when the chair is in the upright position. Concave portions 98 and 98 on the flange 84 are positioned to abut the posts 18 and 20 and are configured to match the curvature of the posts 18 and 20, respectively, at the point of connection between the seat 14 and the rear frame 10. Fasteners 82 extend through the rear frame posts 18 and 20 to secure the rear of the seat 14 to the rear frame 10.

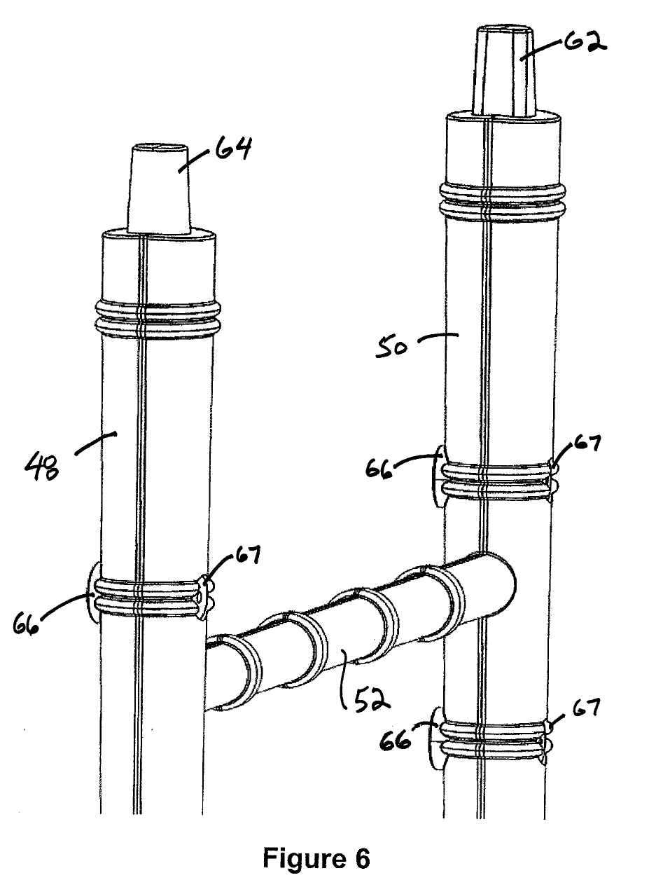

FIG. 6 is an enlarged perspective view of the front frame 12. Protrusions 66 extends rearwardly and are adapted to engage the shoulders or annular flats 70 at the ends of the jackets 74 which form the outside portions of the connecting rods 16. Recesses 67 in the front face of the front frame 12 are adapted to receive the heads of fasteners used to connect the front frame 12 to the front-to-rear connecting rods 16. As discussed above, the D-shaped tapered plugs 62 and 64 are adapted to snugly fit into the D-shaped tapered recesses or sockets 78 that are formed in the front corners of the seat 14.

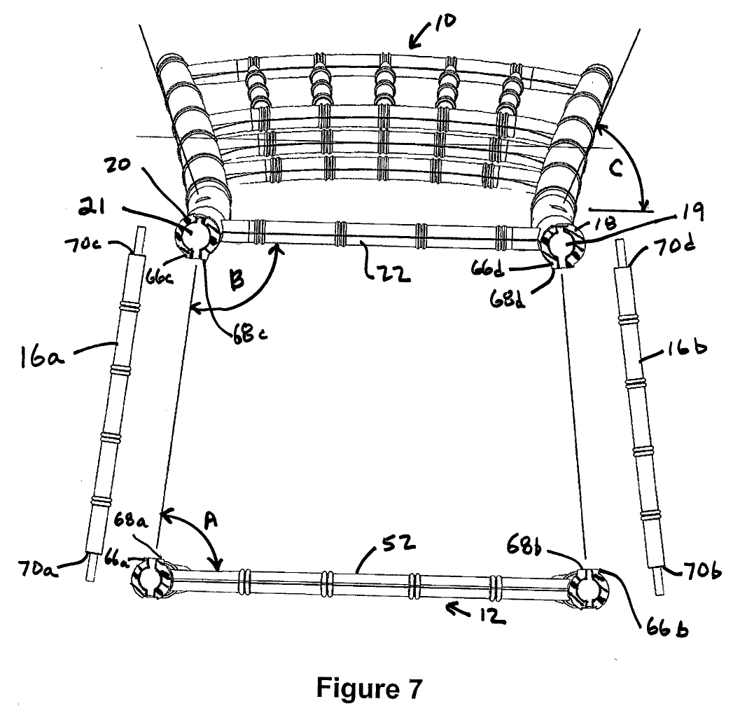

FIG. 7 is an exploded upwardly directed view in partial section of the chair that embodies the inventions described herein. At the seat level, the front frame 12 is wider than the rear frame 10. Therefore, the connecting rods 16A and 16B are not parallel to each other. In order to assemble the chair depicted in FIG. 7, holes are drilled at the locations of the protrusions 66 in the front frame 12 and at the locations of the protrusions 66 in the rear frame 10. The protrusion 66a on the rear frame 10 faces the protrusions 66c on the front frame 12, and the corresponding annular flats 68a and 68c are generally parallel to each other. Similarly, protrusion 66b on the rear frame 10 faces the protrusions 66d on the front frame 12, and the corresponding annular flats 68b and 68d are generally parallel to each other. The protrusion 66a has annular flat 68A that abuts the annular flat 70a on one end of connecting rod 16a, and protrusion 66c on the rear frame 10 has annular flat 68c which abuts the corresponding annular flat 70c on the opposite end of the connecting rod 16a when fasteners are used to assemble the connecting rod 16a between the front frame 12 and the rear frame 10. Similarly, protrusion 68b on the front frame 12 has an annular flat 66b that engages and abuts the annular flat or shoulder 70b at one end of the connecting rod 16b. The rear frame 10 has a protrusion 66d with an annular flat 68d that abuts and engages an annular flat 70d on the shoulder of one end of the connecting rod 16b when fasteners are used to connect each end of the connecting rod 16b between the front frame 12 and the rear frame 10.

As can be seen in FIG. 7, the front frame 12 is generally wider than the rear frame 10, at least at the elevation where the seat 14 and the front-to-rear connecting rods 16 connect to the front and rear frames. The protrusions 66 a, b, c and d, therefore, must be formed at angles to each other such that the rods 16a and 16b, when connected between the front and rear frames, are not parallel, but instead form an angle B of about 96 degrees with respect to the cross bar 22 of the rear frame 10 and an angle A of about 84 degrees with respect to the upper rung 52 of the front frame 12. It is important that the annular flats 68 be formed in accordance with these angles so that when the fasteners used to connect the frames to the connecting rods, the annular flats on the frames will tightly and securely bear against the annular flats 70 at the ends of the connecting rods 16. It is also important that the holes drilled in the frame through which the fasteners used to connect the rods 16 to the frames be drilled perpendicular to the respective annular flats 68. Angle C (about 72 degrees) as shown FIGS. 7 and 5 shows the direction of the holes used to connect the rear of the seat 14 to the rear frame 10. Angle C can also be seen in FIG. 5.

Polycarbonate is particularly well-suited for use in making chairs of the kind shown and described herein. First, the viscosity of polycarbonate is well-suited to GAIM technology. Second, the strength and toughness of polycarbonate allows the relatively elegant and thin and hollow sections of a Chiavari chair to be highly durable and suitable for use as rental equipment. However, other resins, such as Acrylic or Nylon, could be used, depending upon the priorities given to things such as transparency, strength, cost and other factors.

To mold and assemble a chair using with the features and attributes discussed above, the rear frame 10 and the front frame 12 are molded using GAIM technology. Polycarbonate is injected into a rear frame mold and pressurized gas (preferably nitrogen gas) is inserted into interior spaces of the posts 18 and 20 of the rear frame 10, and gas is forced at least partially into the cross bars 24, 26 and 28 that bridge from post 18 to post 20. Gas is inserted into the rear frame 10 through ports 91 and 93 at upper rear portions of the posts 18 and 20, respectively. Once the posts 18 and 20 are substantially hollowed, and the cross bars 22, 24, 26 and 28 are at least partially hollowed by the displacement of polycarbonate by gas, and the polycarbonate has sufficiently cooled, the rear frame is ejected from the rear frame mold. The front frame is formed in a similar manner, i.e., polycarbonate is injected into a front frame mold and pressurized gas (preferably nitrogen gas) is inserted into interior spaces of the posts 48 and 50 of the front frame 12, and gas is forced at least partially into the cross bars that bridge from post 48 to post 50. Gas is inserted into the front frame 12 through ports 94 and 96 at the upper rear portion of the posts 48 and 50, respectively. Once the posts 48 and 50 are substantially hollowed, and the rungs 52 and 54 are at least partially hollowed by the displacement of polycarbonate by gas, and the polycarbonate has sufficiently cooled, the front frame is ejected from the front frame mold.

The front and rear frames 10 and 12 are drilled to form holes (at angles as depicted in FIG. 7) to make way for the ten fasteners used to hold the chair together, as discussed below.

The seat is formed using a regular (i.e., non-GAIM) injection mold. Polycarbonate is the preferred material, because of its clarity, strength and toughness, particularly for chairs that will be used as rental equipment.

The front-to-rear connecting rods 16 are formed using insert molding. A polycarbonate jacket 74 is molded around a steel rod 72. The rod 72 is place into a cavity in a connecting rod mold, the mold is closed and polycarbonate is injected into spaces around the central portion of the rod 72, leaving the ends of the rod exposed. When the polycarbonate is sufficiently cooled, the rod 16 is ejected from the connecting rod mold. All four of the rods used to assembly a chair are preferably identical to each other making assembly simple, and making it less likely for assembly errors to occur.

The clear and transparent nature of polycarbonate resin gives a chair made in accordance with the methods described herein a crystal-like appearance, and such appearance is popular and desirable, particularly for wedding and similar events, such as anniversaries. However, it is quite feasible to include colorant into the polycarbonate resin to render the resulting chair any number of tinted shades, while maintaining both translucence and transparency, while providing a different color accent to an event. Other colorants and/or additives may also be used to achieve various visual effects that may not be transparent or even translucent, such as to make the chair opaque white or to make a chair have a wood-look.

Once all seven components of a chair are molded, the chair is ready for final assembly. Two bolts and two nuts are used to hold the rear of the seat 14 in place with the ears 30 and 32 of the rear frame 10 fitting into the slots 80 in the underside of the seat 14. The D-shaped plugs 62 and 64 are pushed into the D-shaped sockets 78. In addition to the seat being used to join the front and rear frames 10 and 12, Eight bolts are used to connect the four front-to-rear connecting rods 16 to the front and rear frames 10 and 12. The bolts extend through one of the frames and thread into the threaded bores 76 at each end of a rod 16. The annular flats 70 on the shoulders of the jacket 74 of each rod 16 make abutting contact with a correspond flat 68 on the inwardly facing protrusions 66 on the front and rear frames to provide the chair with stability when the bolts are tightened.

Although the inventions described and claimed herein (which collectively may sometimes be referred to herein as the “invention”—singular) have been described in considerable detail with reference to a particular embodiments, persons skilled in the art will appreciate that the inventions may be practiced in ways that differ from the particular embodiment that has been detailed above. The example that has been described was presented for purposes of illustration and not for purposes of limitation. Therefore, the spirit and scope of the appended claims should not be limited to the description of the particular embodiment shown and described herein. Indeed numerous variations, alternatives and modifications will be apparent to persons of skill in the art of injection molding and chair design, and it is intended that combinations that embody all such variations, alternatives and modifications be included within the scope of the appended claims.

1. A combination of injection molded components usable to form a chair comprising:
a rear frame comprising two at least partially hollow rear posts and at least three rear cross bars extending between and monolithically formed with the rear posts, at least one of the rear cross bars being at least partially hollow;
a front frame comprising at least two partially hollow front posts and at least two front cross rungs extending between and monolithically formed with the front posts, each of the front cross rungs being at least partially hollow;
at least four front-to-rear connecting rods each comprising an insert molded jacket surrounding a metal core;
at least eight fasteners, each end of the core of each of the front-to-rear connecting rods being joined to the rear frame and the front frame by one of the fasteners;
a seat comprising a substantially circumferential downwardly depending flange, and sockets near front corners of the seat for receiving upper ends of the front posts.

2. The combination of claim 1 wherein the material comprising at least the front frame and the rear frame is a substantially clear high strength resin selected from the group consisting of: 1) polycarbonate, 2) acrylic and 3) nylon.

3. The combination of claim 2 wherein the material comprising the jackets surrounding the metal cores is a substantially clear high strength plastic selected from the group consisting of: 1) polycarbonate, 2) acrylic and 3) nylon.

4. The combination of claim 1 wherein the material comprising the front frame and the rear frame and the material comprising the jackets surrounding the metal cores is a polycarbonate resin.

5. The combination of claim 4 wherein the polycarbonate resin is tinted.

6. The combination of claim 1 further comprising:
at least four protrusions each with a planar surface formed on each of the front and rear frames, and planar shoulders formed at the ends of each of the insert molded jackets, the planar surfaces on the protrusions abutting the planar surfaces on the shoulders upon tightening of the fasteners, the planar abutting surfaces being generally perpendicular to the front-to-rear connecting rods.

7. The combination of claim 6 wherein:
two planar surfaces formed on the protrusions on one post of the rear frame are formed such that when the combination is assembled to form a chair they are generally parallel to an opposing pair of planar surfaces on the front frame, and generally parallel to annular flats at opposite ends of two of the connecting rods.

8. The combination of claim 6 further comprising:
the front frame and the rear frame each having at least four recesses, each of the recesses being disposed on a diametrically opposite one of the protrusions, the recesses being adapted to received the head of a fastener.

9. The combination of claim 1 further comprising:
at least two ears, each ear extending laterally from a central portion of the rear frame, the ears engaging the rear lip and providing vertical support for the seat.

10. The combination of claim 1 further comprising:
at least two seat fasteners, each seat fastener extending through the rear frame and engaging a formation on the seat that abuts a front-facing portion of each of the rear posts, the formation being shaped to conform to the front-facing portion of each of the rear posts.

11. A combination of injection molded components usable to form a chair comprising:
a rear frame comprising two at least partially hollow rear posts and at least three rear cross bars extending between and monolithically formed with the rear posts, at least one of the rear cross bars being at least partially hollow, the rear frame being comprised substantially of unreinforced polycarbonate;
a front frame comprising at least two partially hollow front posts and at least two front cross rungs extending between and monolithically formed with the front posts, each of the front cross rungs being at least partially hollow, the rear frame being comprised substantially of unnreinforced polycarbonate;
at least four front-to-rear connecting rods each comprised of polycarbonate;
a seat comprising a substantially circumferential downwardly depending flange, and two sockets at front corners of the seat for receiving upper ends of the front posts, the seat being comprised of substantially unreinforced polycarbonate.

12. The combination of claim 11 further comprising at least eight fasteners, each end of the core of each of the front-to-rear connecting rods being joined to the rear frame and the front frame by one of the fasteners, each front-to-rear connecting rod comprising a jacket of polycarbonate insert molded around a metal core.

13. The combination of claim 12 further comprising:
at least four protrusions each with a planar surface formed on each of the front and rear frames, and planar shoulders formed at the ends of each of the insert molded jackets, the planar surfaces on the protrusions abutting the planar surfaces on the shoulders upon tightening of the fasteners, the planar abutting surfaces being generally perpendicular to the front-to-rear connecting rods.

14. The combination of claim 13 wherein:
two planar surfaces formed on the protrusions on one post of the rear frame are formed such that when the combination is assembled to form a chair the planar surface on the rear frame are generally parallel to an opposing pair of planar surfaces on the front frame, and generally parallel to annular flats at opposite ends of two of the four front-to-rear connecting rods.

15. The combination of claim 13 further comprising:
the front frame and the rear frame each having at least four recesses, each of the recesses being disposed on a diametrically opposite one of the protrusions, the recesses being adapted to received the head of a fastener.

16. The combination of claim 11 further comprising:
at least two ears, each ear extending laterally from a central portion of the rear frame, the ears engaging the rear lip and providing vertical support for the seat.

17. The combination of claim 11 further comprising:
at least two seat fasteners, each seat fastener extending through the rear frame and engaging a formation on the seat that abuts a front-facing portion of each of the rear posts, the formation being shaped to conform to the front-facing portion of each of the rear posts.

18. A method of making a set of components for assembling a chair comprising:
injection molding substantially clear polycarbonate into a rear frame mold to form a rear frame, and using pressurized gas in the rear frame mold to form substantially two hollow rear posts in the rear frame and using the pressurized gas to at least partially hollow a plurality of cross bars joining the rear posts,
ejecting the rear frame from the rear frame mold,
injection molding substantially clear polycarbonate into a front frame mold cavity to form a front frame, and using pressurized gas in the front frame mold to form substantially two hollow front posts in the front frame and using the pressurized gas to at least partially hollow a plurality of cross bars joining the front posts,
ejecting the front frame from the front frame mold,
insert molding at least four front-to-rear connecting rods by injection molding a substantially clear polycarbonate jacket onto four metal connecting rods using a connecting rod mold,
ejecting each of the four connecting rod jackets from the connecting rod mold,
injection molding substantially clear polycarbonate into a seat mold to form a seat and ejecting the seat from the seat mold.

19. A method in accordance with claim further comprising:
drilling a plurality of holes through each of the front and rear frames.

20. A set of chair components made by the process of claim 18.
